(19) United States
(12) Patent Application Publication
(10) Pub. No.: US 2024/0386280 A1
(43) Pub. Date: Nov. 21, 2024

(54) Knowledge Distillation Training via Encoded Information Exchange to Generate Models Structured for More Efficient Compute

(71) Applicant: Google LLC, Mountain View, CA (US)

(72) Inventors: Zhe Zhao, San Francisco, CA (US); Huan Gui, Mountian View, CA (US); Qingyun Liu, San Carlos, CA (US); Ed Huai-hsin Chi, Los Altos Hills, CA (US); Lichan Hong, Los Altos, CA (US); Bang An, Rockville, MD (US)

(21) Appl. No.: 18/667,973

(22) Filed: May 17, 2024

Related U.S. Application Data
(60) Provisional application No. 63/502,890, filed on May 17, 2023.

(51) Int. Cl. G06N 3/096; G06N 3/0455

(52) U.S. Cl. CPC G06N 3/096; G06N 3/0455

(57) ABSTRACT

A computer-implemented method to generate a second machine learning model based on a first machine learning model, wherein the second machine learning model is structured for more efficient computation, is provided. The method includes processing an input with a hidden layer of a student machine-learned model to obtain an intermediate output. The method includes providing an encoded message descriptive of the input and the intermediate output for processing with a teacher machine-learned model. The method includes, responsive to providing the encoded message, obtaining a second encoded message descriptive of a second intermediate output of one or more hidden layers of the teacher machine-learned model. The method includes performing a knowledge distillation training process to train the student machine-learned model based on a difference between the intermediate output and the second intermediate output.

### PRIORITY CLAIM

The present application is based on and claims priority to U.S. Provisional Application 63/502,890 having a filing date of May 17, 2023, which is incorporated by reference herein.

### FIELD

The present disclosure relates generally to knowledge distillation training of machine-learned models. More particularly, the present disclosure relates to knowledge distillation training via encoded information exchange between teacher models and student models.

### BACKGROUND

Knowledge Distillation uses knowledge from a larger, more powerful “teacher” model to improve the performance of a smaller, more efficient “student” model. In recent years, knowledge distillation has been used in many applications such as natural language processing, computer vision, and Recommendation Systems, and has demonstrated significant quality improvements. However, recent research discoveries in understanding knowledge distillation suggest that larger teacher does not necessarily guarantee a better student, on the contrary, a huge capacity gap between teachers and students can lead to small to no improvement to students, due to specific representation that can only be learned with large capacity.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method to generate a second machine learning model based on a first machine learning model, wherein the second machine learning model is structured for more efficient computation. The method includes processing, by a computing system comprising one or more processor devices, an input with a hidden layer of a student machine-learned model to obtain an intermediate output. The method includes providing, by the computing system, an encoded message descriptive of the input and the intermediate output for processing with a teacher machine-learned model. The method includes, responsive to providing the encoded message, obtaining, by the computing system, a second encoded message descriptive of a second intermediate output of one or more hidden layers of the teacher machine-learned model. The method includes performing, by the computing system, a knowledge distillation training process to train the student machine-learned model based on a difference between the intermediate output and the second intermediate output.

Another example aspect of the present disclosure is directed to a computing system. The computing system includes one or more processors and one or more tangible, non-transitory computer readable media storing computer-readable instructions that when executed by the one or more processors cause the one or more processors to perform operations. The operations include obtaining an encoded message descriptive of an input and an output of a hidden layer of a student machine-learned model, wherein the input comprises a low-level intermediate student output generated using a layer of the student machine-learned model preceding the hidden layer, and wherein the output comprises a high-level intermediate student output. The operations include decoding the encoded message with a machine-learned message decoding model to obtain an interpreted low-level intermediate teacher output. The operations include processing the interpreted low-level intermediate teacher output with a hidden layer of the teacher machine-learned model to obtain a high-level intermediate teacher output. The operations include encoding the high-level intermediate teacher output with a machine-learned message encoding model to obtain a second encoded message. The operations include providing the second encoded message for performance of a knowledge distillation training process to train the student machine-learned model based on a difference between the high-level intermediate student output and the high-level intermediate teacher output.

Another example aspect of the present disclosure is directed to a One or more tangible, non-transitory computer readable media storing computer-readable instructions that when executed by one or more processors cause the one or more processors to perform operations. The operations include processing a low-level intermediate student output with a hidden layer of a machine-learned student model to obtain a high-level intermediate student output. The operations include generating an interpreted low-level intermediate teacher output based on the low-level intermediate student output. The operations include processing the interpreted low-level intermediate teacher output with a hidden layer of a machine-learned teacher model to obtain a high-level intermediate teacher output. The operations include performing a knowledge distillation training process to train the student machine-learned model based on a difference between the high-level intermediate student output and the high-level intermediate teacher output.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs knowledge distillation training to generate a machine learning model structured for more efficient compute according to example embodiments of the present disclosure.

FIG. 1B depicts a block diagram of an example computing device that performs knowledge distillation training to generate a machine learning model structured for more efficient compute according to example embodiments of the present disclosure.

FIG. 1C depicts a block diagram of an example computing device that utilizes a machine learned model trained via knowledge distillation according to example embodiments of the present disclosure.

FIG. 2A is a block diagram of an early Schramm model for one-way interpersonal communication according to some implementations of the present disclosure.

FIG. 2B is a block diagram of an Osgood-Schramm model for two-way interpersonal communication according to some implementations of the present disclosure.

FIG. 3A depicts a data flow diagram for a method to generate a second machine learning model based on a first machine learning model, wherein the second machine learning model is structured for more efficient computation according to example embodiments of the present disclosure.

FIG. 3B is a block diagram for training a student machine-learned model based on an optimization function that evaluates a distance original hidden states and returned hidden states according to some implementations of the present disclosure.

FIG. 4 depicts a flow chart diagram of an example method to perform knowledge distillation training via encoded information exchange according to example embodiments of the present disclosure.

FIG. 5 depicts a flow chart diagram of an example method to perform a knowledge distillation training process with interactive communication according to example embodiments of the present disclosure.

Reference numerals that are repeated across plural figures are intended to identify the same features in various implementations.

### DETAILED DESCRIPTION

### Overview

Generally, the present disclosure is directed to knowledge distillation training. More particularly, the present disclosure relates to knowledge distillation training via encoded information exchange between teacher models and student models to generate machine-learned models that are structured for more efficient computation. Knowledge distillation training refers to the distillation of knowledge from a trained model (i.e., a “teacher” model) to an untrained model (i.e., a “student” model) that is more computationally efficient than the trained model. For example, a student model may include an order of magnitude fewer parameters than a teacher model, making the student model more computationally efficient.

By incorporating the exchange of encoded information, this process can be optimized to generate machine-learned models that are structured for more efficient computation via distillation of knowledge from machine-learned teacher models to machine-learned student models. For example, a computing system (e.g., a system for training machine learning models) can process an input with the initial layer(s) of a machine-learned student model (i.e., the model to be trained via knowledge distillation) to obtain a low-level intermediate student output. The computing system can process the low-level intermediate student output with a hidden layer (e.g., an attention layer, a transformer layer, a convolutional layer, etc.) to obtain a high-level intermediate student output.

The computing system can encode the low-level intermediate student output with a machine-learned message encoding model to generate an encoded message. The machine-learned message encoding model can be trained in conjunction with a machine-learned message decoding model to interpret intermediate student representations to intermediate teacher representations. For example, due to the different computational structure of the student model, the low-level intermediate student output may be formatted differently than a corresponding low-level intermediate teacher output of a machine-learned teacher model. However, by training the machine-learned message encoder and decoder models to interpret between intermediate student outputs and intermediate teacher outputs, the computing system can enable processing of intermediate student outputs using layers of a machine-learned teacher model, and vice-versa.

Accordingly, the computing system can decode the encoded message with the machine-learned message decoding model to obtain an interpreted low-level intermediate teacher output. The computing system can process the interpreted low-level intermediate teacher output with a hidden layer of the machine-learned teacher model that corresponds to the hidden layer of the machine-learned student model to obtain a high-level intermediate teacher output. The computing system performing a knowledge distillation training process to train the student machine-learned model based on a difference between the high-level intermediate student output and the high-level intermediate teacher output. In such fashion, the computing system can distill knowledge from the machine-learned teacher model to the machine-learned student model while retaining the benefits of the computationally efficient structure of the student model.

Aspects of the present disclosure provide a number of technical effects and benefits. As one example technical effect and benefit, many contemporary models, such as large language models or other “large” models, require a substantial quantity of compute resources to be utilized for inference. This quantity of compute resources generally exists only in data centers, rendering the use of such models impossible for most devices (e.g., smartphones, desktop computers, laptops, wearable devices, etc.). However, implementations of the present disclosure can distill knowledge from “teacher” models to “student” models that are structured for more efficient computation in a manner that retains much of the performance achieved by the teacher models while enabling the utilization of the student models across a variety of devices. In such fashion, implementations of the present disclosure can substantially increase the number of scenarios in which machine-learned models can be leveraged, while also reducing the expenditure of computing resources required by such models.

With reference now to the Figures, example embodiments of the present disclosure will be discussed in further detail.

### Example Devices and Systems

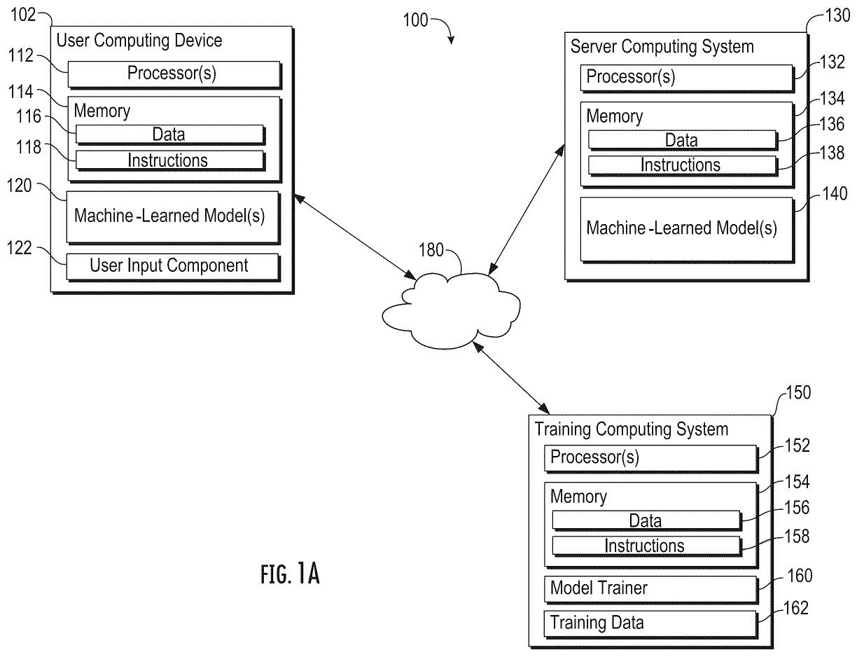

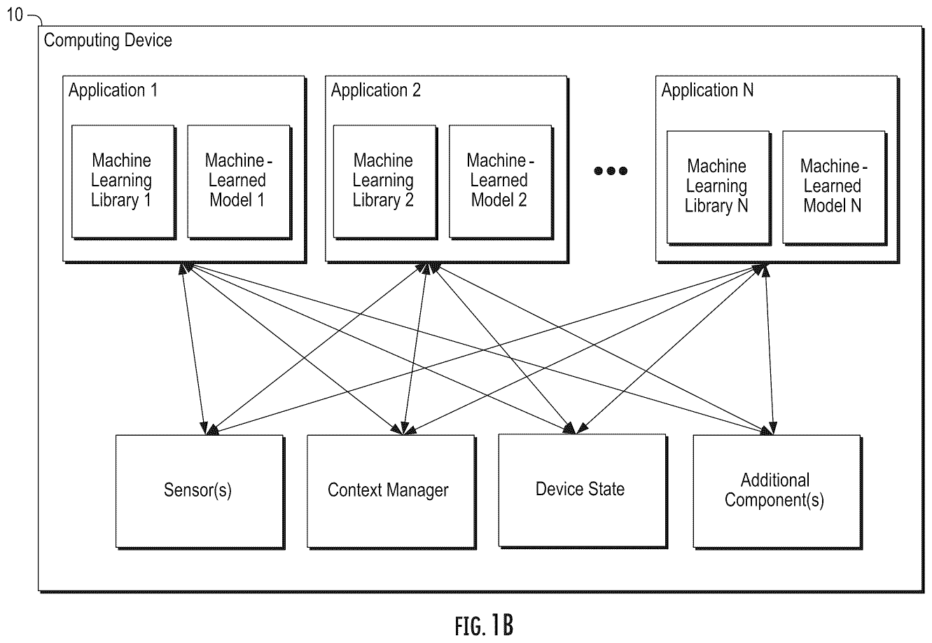

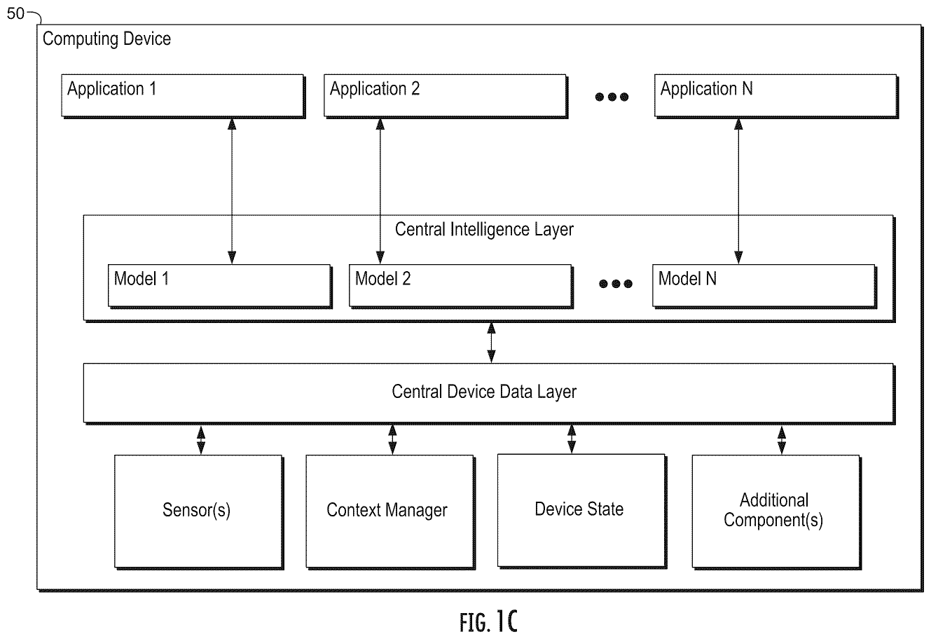

FIG. 1A depicts a block diagram of an example computing system 100 that performs knowledge distillation training to generate a machine learning model for more efficient compute according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more models 120. For example, the models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, the one or more models 120 can be received from the server computing system 130 over network 180, stored in the user computing device memory 114, and then used or otherwise implemented by the one or more processors 112. In some implementations, the user computing device 102 can implement multiple parallel instances of a single model 120 (e.g., to perform parallel processing across multiple instances of the model 120).

Additionally or alternatively, one or more models 140 can be included in or otherwise stored and implemented by the server computing system 130 that communicates with the user computing device 102 according to a client-server relationship. For example, the models 140 can be implemented by the server computing system 140 as a portion of a web service (e.g., a generative service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the models 120 and/or 140 based on a set of training data 162. In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs knowledge distillation training to generate a machine learning model structured for more efficient compute according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that utilizes a machine learned model trained via knowledge distillation according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

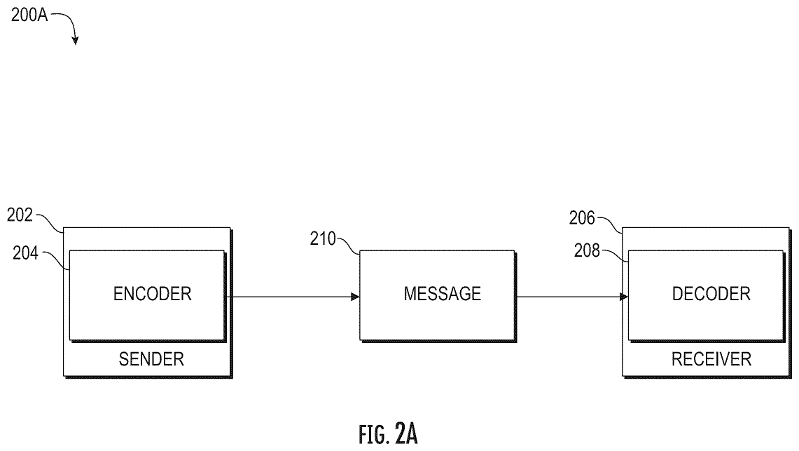

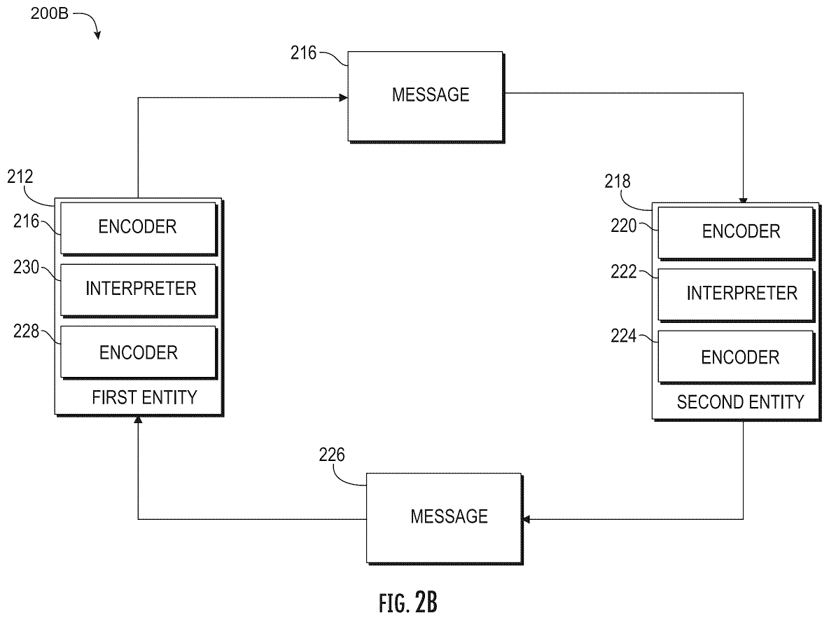

FIG. 2A is a block diagram of an early Schramm model 200 for one-way interpersonal communication according to some implementations of the present disclosure. The early Schramm model 200A can be a one-way communication model in which a sender encodes a message and passes it to a receiver to decode. More specifically, the Schramm model 200A can include a “sender” entity 202. The sender entity 202 can be any type or manner of entity, such as a computing system, device, user, etc. The sender entity 202 can include an encoder 204. In some implementations, the encoder 204 can refer to a software-based encoder, such as a machine-learned model, encoding schema, etc. Alternatively, the encoder 204 may be a logical representation of the mental process of a human encoding information in speech before speaking.

The early Schramm model 200A can include a receiver entity 206 with a decoder 208 Similar to the sender 202 and the encoder 204, the receiver entity 206 can be any type or manner of entity, such as a computing system, person, etc. The decoder 208 can decode a message 210 received from the sender 202 that is encoded by the encoder 204. In other words, the sender 202 can encode the message 210 with the encoder 204, and can provide the encoded message 210 to the receiver 206. The receiver 206 can decode the encoded message 210 to ingest the message 210. In this manner, one-way interpersonal communication can be performed in accordance with the early Schramm model 200A.

FIG. 2B is a block diagram of an Osgood-Schramm model 200B for two-way interpersonal communication according to some implementations of the present disclosure. The Osgood-Schramm model 200B can be a two-way communication model in which a first entity encodes a message and passes it to a second entity to decode and interpret. The second entity can then encode its own message and provide the encoded message to the first entity as a reply. More specifically, the Osgood-Schramm model 200B can include a first entity 212. The first entity 212 can be a computing system, device, machine-learned model, set or grouping of machine-learned models, etc. that can encode, decode, and/or interpret, messages for communication. The first entity 212 can include an encoder 214. In some implementations, the encoder 214 can refer to a software-based encoder, such as a machine-learned model (or portion thereof), encoding schema, etc. The first entity can encode a message 216 and send the message 216 to a second entity 218.

The second entity 218 can receive the message 216 that is encoded with the encoder 212. For example, the encoder 212 can apply an encoding schema to the message 216 to encode the message. For another example, the encoder 212 can be a machine-learned model that processes the message 216 to encode the message 216. The second entity 218 can include a decoder 220 that can decode the message 216 using a decoding process that corresponds to the encoding process used to encode the message 216.

The second entity 218 can include an interpreter 222. The interpreter 222 can interpret messages. More specifically, once decoded, the second entity 218 can process the message 216 with the interpreter 222 to interpret the message. As described herein, a message can be “interpreted” by processing the message to extract some information from the message. The second entity 218 can include an encoder 224. The second entity can generate a second message 226 and encode the second message 226 with the encoder 224. The second entity 218 can then send the second message 226 to the first entity 212.

The first entity 212 can include a decoder 228 in the same manner as described with regards to the decoder 220 of the second entity 218. The first entity 212 can decode the second message 226 with the decoder 228. The first entity 212 can also include an interpreter 230 to interpret the message 226 once decoded. Finally, the first entity 212 can respond to the second message 226 by generating a third message and encoding the third message with the encoder 216 prior to transmitting the third message to the second entity 218. In this manner, the first and second entities 212 and 218 can communicate in accordance with the illustrated Osgood-Schramm model 200B for communication.

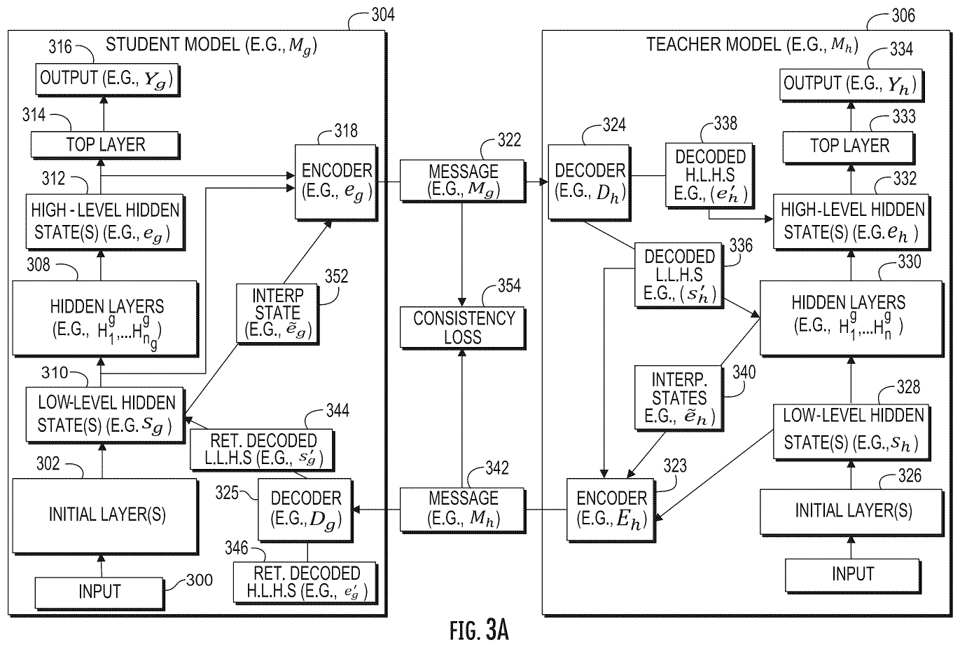

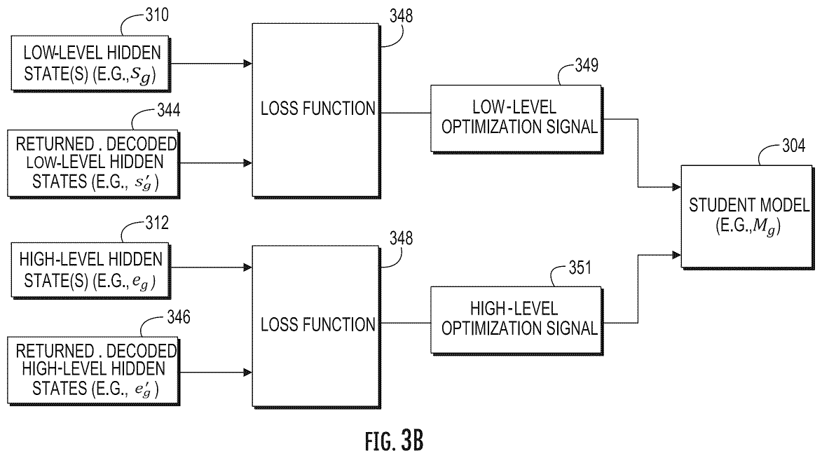

FIG. 3A depicts a data flow diagram for a method to generate a second machine learning model based on a first machine learning model, wherein the second machine learning model is structured for more efficient computation according to example embodiments of the present disclosure. An input 302 can be obtained for a student machine-learned model 304. The student machine-learned model 304 can include initial layer(s) 302 that can initially process the input 300 to obtain low-level hidden state(s) 306. The input 300 can be any type or manner of information that can be processed by the student machine-learned model 304 for training and/or inference. For example, the input 300 may be a training example for training of machine-learned models, such as textual data, image data, encoded data, multiple types of data or multimodal data, etc.

As described herein, the student machine-learned model 304 can be a model that is trained, optimized, or otherwise implemented based at least in part on a teacher machine-learned model 306. In some implementations, the student machine-learned model 304 can be trained to emulate the teacher machine-learned model 306 while utilizing fewer computing resources for inference (e.g., a distillation model trained via distillation training) Additionally, or alternatively, in some implementations, the student machine-learned model 304 can be a model with a different architecture than the teacher machine-learned model 306.

More specifically, the student machine-learned model 304 can include initial layer(s) 302. The initial layer(s) 302 can include one or more layers that initially process the input 300 and/or any intermediate outputs of preceding initial layers. In some implementations, the initial layer(s) 302 can include a first portion of hidden layers 308. As described herein, a “hidden layer” generally refers to any layer that is not an input or output layer for the model (e.g., convolutional layers, multi-layer perceptrons, transformer layers, etc.).

Alternatively, the input 300 can be processed by the initial layer(s) 302 to obtain an intermediate output (not illustrated) that is subsequently processed by hidden layers 308. As such, it should be noted that, in some implementations, the initial layer(s) 302 may depict a first portion of the hidden layers 308. The hidden layers 308, which can be represented as H₁^{g}, . . . Hₙ_{_{g}}^{g}, can include a low-level portion including layers from H₁^{g} to Hₗ_{_{g}}^{g}, and a high-level portion including layers from Hₗ_{_{g}}₊₁^{g} to Hₕ_{_{g}}^{g}.

The hidden layers 308 can include hidden states. As described herein, a “hidden state” refers to some information derived from prior input(s) and/or current input(s) (e.g., the input 300) to the hidden layers 308. For example, if the hidden layers 308 include a Long Short-Term Memory (LSTM) layer, the hidden state for the LSTM layer may refer to the memory information stored by the LSTM over time. For another example, if the hidden layers 308 include attention layers, the hidden state for the attention layers may refer to the attention weights of the layers.

In particular, the lower layers of the hidden layers 308 (e.g., layers from H₁^{g} to Hₗ_{_{g}}^{g}) can include low-level hidden states 310. Similarly, the higher layers of the hidden layers 308 (e.g., layers from Hₗ_{_{g}}₊₁^{g} to Hₕ_{_{g}}^{g}) can include high-level hidden states 312. The student machine-learned model 304 can also include a top, or “final” layer 314 that produces an output 316 based on an intermediate representation received from the hidden layers 308. For example, given the student machine-learned model 304, which is represented as model M_{g}, the model M_{g} can generate an output as represented by:

$${y}_{g} = {H}_{{h}_{g} + 1 , ... , {n}_{g}}^{g} ( {e}_{g} ) = {H}_{{h}_{g} + 1 , ... , {n}_{g}}^{g} ( {H}_{{l}_{g} + 1 , ... , {h}_{g}}^{g} ( {s}_{g} ) ) = {H}_{{h}_{g} + 1 , ... , {n}_{g}}^{g} ( {H}_{{l}_{g} + 1 , ... , {h}_{g}}^{g} ( {H}_{1 , ... {l}_{g}}^{g} ( x ) ) )$$

The student machine-learned model 304 can include an encoder portion 318. Once the output 312 y_{g} is generated, the encoder portion 318 can process the low-level hidden states 310, which are represented as s_{g}, and the high-level hidden states 312, which are represented as e_{g}, to obtain an encoded message 320, represented as m_{g}. In other words, the message m_{g}=E_{g}({s_{g}; e_{g}}).

The teacher machine-learned model 306 can include a decoder portion 324, along with an encoder portion 323 that corresponds to the encoder portion 318. In other words, the decoder portion 324 of the teacher machine-learned model 306 can be configured to decode messages encoded using the encoding portion 318 of the student machine-learned model 304. Similarly, the encoder portion 323 of the teacher machine-learned model 306 can be configured to encode messages encoded using a decoding portion 325 of the student machine-learned model 304.

In some implementations, the teacher machine-learned model 306 can also include initial teacher layers 326, low-level teacher hidden states 328, hidden teacher layers 330, high-level teacher hidden states 332, a top teacher layer 333, and/or a corresponding output 334. The teacher model 306 can decode the encoded message 322 with the decoder portion 324 to obtain decoded low-level hidden states 324 and decoded high-level hidden states 326. In other words, the teacher machine-learned model 306, which can be represented as Mₕ, can use the decoder portion 324, which can be represented as Dₕ, to decode the encoded message 322 (e.g., m_{g}). The encoded message 322 can be decoded with the decoder portion 324 into decoded low-level hidden states 336, which can be represented as s′ₕ, and decoded high-level hidden states 338, which can be represented as e′ₕ, such that:

$${M}_{h} : \{ {s}_{h}^{′} ; {e}_{h}^{′} \} = {D}_{h} ( {m}_{g} ) .$$

It should be noted that the message 322 can be generated in a message space, which can be configured based on the structure of the encoder 318 and decoder 324 (or vice-versa). For example, if the student and teacher machine-learned models 304 and 306 are transformer models, the message space of the message 322 can include sequences of embeddings. For another example, the encoder 318 and the decoder 324 can be linear portions with a message space of m∈R^{m}^{_{d}}, where m_{d} is the dimensionality of the message space.

Once the encoded message 322 is decoded with the decoder portion 324 into low-level hidden states 336 (e.g., s′ₕ) and the decoded high-level hidden states 338 (e.g., e′ₕ), the teacher machine-learned model 306 can interpret the decoded message with its own learned weights. To do so, the teacher machine-learned model 306 can interpret the decoded low-level hidden states 336 by inputting the states to the hidden teacher layers 330 of the teacher machine-learned model 306 to obtain interpreted states 340, which can be represented as \tilde{e}ₕ such that \tilde{e}ₕ=Hₗ_{ₕ}_{+1, . . . , h}_{ₕ}^{h} (s′ₕ). The teacher machine-learned model 306 can then encode the interpreted states 340 and the decoded low-level hidden states 336 with the encoder portion 323 to obtain a returned encoded message 342.

It should be noted that interpretation of the decoded states (e.g., 336 and 338) can facilitate the interactive communication process, as it enables the teacher machine-learned model 306 to encode messages to the student machine-learned model 304 with information or knowledge (e.g., model parameters, weights, hyperparameters, etc.) of the teacher model, and further enables such information or knowledge to be applied to the student's messages.

The student machine-learned model 304 can receive the returned encoded message 342, and can decode the returned encoded message 342 with the decoder 325. Specifically, the student machine-learned model 304 can decode the returned encoded message 342 to its hidden space to obtain returned decoded low-level hidden states 344, which can be represented as s′_{g}, and returned decoded high-level hidden states 346, which can be represented as e′_{g}, such that {s′_{g}; e′_{g}}=D_{g}(mₕ).

The student machine-learned model 304 can use at least the returned decoded low-level hidden states 344 to learn from the teacher machine-learned model 306. To do so, the student machine-learned model 304 can be trained by minimizing a distance between the low-level hidden states 310 and the returned decoded low-level hidden states 344.

For a specific example, turning to FIG. 3B, FIG. 3B FIG. 3B is a block diagram for training a student machine-learned model based on an optimization function that evaluates a distance original hidden states and returned hidden states according to some implementations of the present disclosure. Specifically, the student model can be trained based on a distance between the low-level hidden states 310 and the returned decoded low-level hidden states 344 can be determined with a distillation loss function 348. Similarly, a distance between the high-level hidden states 312 and the returned decoded low-level hidden states 346 can be determined with a loss function 348 (e.g., a distillation loss function, etc.).

In some implementations, the loss function 348 can be an interaction loss represented as:

$${L}_{interact} = d ( \{ {s}_{g} ; {e}_{g} \} , \{ {s}_{g}^{′} ; {e}_{g}^{′} \} ) = d ( \{ {s}_{g} ; {e}_{g} \} , {D}_{g} ( {E}_{h} ( \{ {s}_{h}^{′} ; {\tilde{e}}_{h} \} ) ) )$$

where d can be any distance metric used in conventional feature distillation techniques. In some implementations, an L2 loss can be utilized as d. It should be noted that the interaction loss L_{interact} can be utilized to apply teacher's hidden layers and learned weights on interpreted student's messages, instead of the input 300. By doing so, along with the training of both models' encoder and decoder, the teacher machine-learned model 306 can provide feedback that fits the capacity and learned representation space of the student machine-learned model 308. It should further be noted that, in some implementations, e′ₕ is not used to calculate L_{interact} for learning from the teacher machine-learned model 306, but is instead used for training the decoder portion 324 of the teacher machine-learned model 306 in L_{SC}, which will be discussed subsequently.

The loss function 348 can generate a low-level optimization signal 349 based on the evaluation of the low-level hidden states 310 and the returned decoded low-level hidden states 344. The loss function 348 can also generate a high-level optimization signal 351 based on the evaluation of the high-level hidden states 310 and the returned decoded low-level hidden states 344. The low-level optimization signal 349 and the high-level optimization signal 351 can be utilized to train the student machine-learned model 304.

Returning to FIG. 3A, in some implementations, the student machine-learned model 304 can interpret the decoded message 342. More specifically, the student model 304 can interpret at least the returned decoded lower-level hidden states 344 with the hidden layer(s) 308 (and/or the hidden states 310 and 312 of the hidden layers 308) to obtain an interpreted state 352, which can be represented as \tilde{e}_{g} such that \tilde{e}_{g}=Hₗ_{ₕ}_{+1, . . . , h}_{_{g}}^{g} (s′_{g}). The interpreted state 352 can be encoded using the encoder portion 318. More specifically, the encoder portion 318 can encode the interpreted state 352 based on the returned decoded low-level hidden states 344. In other words, the encoder portion 318 can process both the interpreted state 352 and the returned decoded low-level hidden states 344 to obtain a second message mₕ² (not illustrated), such that:

$${m}_{h}^{2} = {E}_{g} ( \{ {s}_{g}^{′} , {\tilde{e}}_{g} \} )$$

Here, mₕ² can refer to the second iteration of the message for interactive communication. The second message mₕ² can be passed to the teacher machine-learned model 306 again to start the next iteration of communication. It should be noted that new iteration of communication will not necessarily consume a new input, and as such, additional communication interactions from the same input 300 can continue indefinitely to further train the student machine-learned model 304 based on the teacher machine-learned model 306. By doing so, rich information from the teacher machine-learned model 306 can be passed to the student machine-learned model 304 based on student's request, even when downstream tasks are extremely sparse. In some implementations, the number of iterations for interactive communication can be controlled by a hyper-parameter.

In some implementations, the encoder portions 318 and 323 and the decoder portions 324 and 325 of the student machine-learned model 304 and the teacher machine-learned model 306, respectively, can be trained based on a consistency loss function 354. More specifically, the consistency loss function 354 can be utilized to teach the encoders and decoders a reasonable aligned projection between the message space and each of the models hidden layers 308 and 330. As such, given the same input to both the teacher machine-learned model 306 and the student machine-learned model 304, encoders of both models should generate similar messages, and the decoded states produced by the decoders should be similar to their original states. To achieve this, a consistency loss function 354 can be utilized to train the encoders 318 and 323, and the decoders 323 and 324, in addition to the training provided to the student machine-learned model 304 with the L_{interact} loss function (e.g., loss function 348 of FIG. 3B).

In some implementations, the consistency loss function 354 can include a message consistency loss. Given the same input x, the encoder portion 318 (e.g., E_{g}) of the student model 304 (e.g., model M_{g}) and the encoder portion 323 (e.g., Eₕ) of the teacher machine-learned model 306 (e.g., model Mₕ) will generate similar messages based on a message space consistency loss L_{MC}, such that:

$${L}_{MC} = d ( {m}_{g} , {m}_{h} ) = d ( {E}_{g} ( {s}_{g} , {e}_{g} ) , {E}_{h} ( {s}_{h} , {e}_{h} ) )$$

Additionally, or alternatively, in some implementations, the consistency loss function 354 can include a state space consistency loss. The state space consistency loss can enforce consistency between the hidden states of the models. More specifically, given the same input x, the hidden states decoded by the two model's message should be consistent with its own hidden states. The state consistency loss L_{SC} can evaluate decoded states and original states such that:

$${L}_{SC} = d ( \{ {s}_{g} ; {e}_{g} \} , {D}_{g} ( {m}_{h} ) ) + d ( \{ {s}_{h} ; {e}_{h} \} , {D}_{h} ( {m}_{g} ) )$$

and can be used to train both the encoder and decoder portions of both models 304 and 306.

In some implementations, the encoder and decoder portions can be trained using a combined loss such that:

$$L ( x , y , {M}_{g} , {M}_{h} ) = L ( y , {y}_{g} ) + {w}_{1} {L}_{interact} + {w}_{2} {L}_{MC} + {w}_{3} {L}_{SC}$$

where L(y, y_{g}) is the ground truth loss, and w₁, w₂ and w₃ are hyper-parameters of loss weights.

It should be noted that, even though three losses can be utilized (e.g., (L_{interact}, L_{MC} and L_{SC}), the parameters added for the encoder portions and decoder portions are comparable to other feature distillation techniques. During training of the student machine-learned model 304, each portion of the teacher machine-learned model 306 can be frozen other than the encoder portion 323 and the decoder portion 324. As such, the student machine-learned model 304 (including the encoder 318 and the decoder 325), the encoder portion 323, and the decoder portion 324 of the teacher machine-learned model 306 can be trained together, and thus does not necessitate additional weights for training.

Implementations described herein provide a number of technical effects and benefits. As one example, implementations described herein, which is represented in the following table as (TD), demonstrates substantial improvements compared to conventional approaches. Specifically, the first below table demonstrates the relative improvement of different distillation methods (e.g., LD, FD, Fitnet, Hybrid, and the implementation described herein (TD)) compared to a student model without distillation:

| Methods | ML(Dense) | ML(Sparse) | CIFAR10 | CIFAR100 | ImageNet | Avg. |
|---|---|---|---|---|---|---|
| Train from Scratch | (-baseline to calculate relative improvement-) | | | | | |
| LD | +0.16% | +1.49% | +0.03% | +1.86% | −0.21% | +0.83% |
| FD | +0.29% | +2.68% | −0.12% | −0.08% | −0.14% | +0.66% |
| FitNet | +0.81% | +2.19% | −0.09% | +0.53% | +0.29% | +0.93% |
| Hybrid | +0.93% | +2.91% | +0.23% | +1.94% | +0.02% | +1.50% |
| Our Method (TD) | +1.34% | +3.39% | +0.45% | +2.41% | +2.56% | +2.54% |

The columns above represent different datasets used during testing (e.g., MovieLens (ML)), ImageNet, etc.). These datasets cover applications of recommendation and image classification. For some datasets (e.g., ML), the dataset can be split by timestamps so that a portion (e.g., 90%) of the past events can be used to train models evaluated by the 10% of the future events, which is relatively close to a “real-world” setup. For example, a pretrained task can be used to predict movie ratings given a user and a movie for all genres of movies. A corresponding downstream task can refer to a movie rating prediction task for a specific genre. In some implementations, the teacher machine-learned model 306 can be, or otherwise include, a multi-layer perceptron model and the student model can have a smaller proportion of neurons in comparison to the teacher model (e.g., ¼ of the neurons for each layer in teacher model). For evaluating image classification datasets, the teacher machine-learned model 306 can be or otherwise include a vision model, such as a vision transformer. A large vision transformer teacher model can be trained (e.g., on a dataset such as ImageNet21K) and student models can be evaluated using other datasets (e.g., CIFAR10, CIFAR100 and ImageNet. For example, the teacher machine-learned model 306 can include a pre-trained 12-layer vision transformer model, and the student machine-learned model 304 can utilize the same architecture with a smaller number of hidden layers (e.g., transformer layers).

The second table demonstrates the relative improvement of using improvement of using interactive communication approaches described herein:

| Methods | ML(Dense) | ML(Sparse) | CIFAR10 | CIFAR100 | ImageNet | Avg. |
|---|---|---|---|---|---|---|
| Train from Scratch | (-baseline to calculate relative improvement-) | | | | | |
| No Interaction | +0.81% | +2.02% | +0.43% | +2.26% | +2.44% | +1.99% |
| 1 iteration | +1.31% | +3.08% | +0.42% | +2.31% | +2.49% | +2.40% |
| >1 iterations | +1.34% | +3.30% | +0.45% | +2.41% | +2.56% | +2.52% |

In some implementations, the training process for training the student machine-learned model 304 described above can be represented by the following algorithm. It should be noted that, in some implementations, the state consistency loss L_{SC} and message consistency loss L_{MC} may only be applied on m_{g}⁰ and mₕ⁰, which require input x being fed to both teacher and student. These two losses can be used to train encoders and decoders. They can be disabled in the later training stage. Alternatively, without these losses, the teacher model can forego access to any input data x of downstream tasks.

```
Algorithm (Pseudo-code):
  - REQUIREMENTS: Trained teacher model Mₕ, initialized student model M_{g} (or a
pretrained smaller model). Initialized encoders (E_{g}, Eₕ) and decoders (D_{g}, Dₕ) for both teacher
and students. Downstream dataset D = {X, Y}. k iterations for interactive communication.
  1. get x and y from D;
  2. L = 0.0 // Total loss;
  3. y_{g}, {s_{g}; e_{g}} = M_{g}(x);
  4. m_{g}⁰ = E_{g}({s_{g}; e_{g}});
  5. yₕ, {sₕ; eₕ} = Mₕ(x);
  6. mₕ⁰ = Eₕ ({sₕ; eₕ});
  7. // Adding state consistency and message consistency loss to train;
  8. // communication encoders/decoders;
  9. L = L(y, y_{g}) + w₂L_{SC}(m_{g}⁰, Dₕ, mₕ⁰, D_{g}) + w₃L_{MC}(m_{g}⁰, mₕ⁰);
  10. FOR each iteration i in [0, k], DO:
    11. {s_{h′}; e_{h′}} = Dₕ (m_{g}ⁱ) // Teacher decodes message from student;
    12. \tilde{e}ₕ = Hₗ_{ₕ}_{+1,...,h}_{ₕ}^{h} (s_{h′}) // Teacher interpreting step;
    13. mₕⁱ⁺¹ = E_{g}({s_{h′}, \tilde{e}ₕ}) // Teacher encodes returned message;
    14. {s_{g′}; e_{g′}} = D_{g}(mₕⁱ⁺¹) // Student decodes returned message;
    15. L = L + w₁L_{interact}({s_{g}; e_{g}}, {s_{g′}; e_{g′}}) // Interactive communication loss for
iteration i;
    16. \tilde{e}_{g} = Hₗ_{_{g}}_{+1,...,h}_{_{g}}^{g} (s_{g′}) // Student interpreting step for next iteration;
    17. {s_{g}; e_{g}} = {s_{g′}; \tilde{e}_{g}} // set student state for next iteration;
    18. m_{g}ⁱ⁺¹ = E_{g}({s_{g}; e_{g}}) // Student encodes message for next iteration;
    19. END FOR; and
  20. Use optimizer to update the model via total loss L.
```

In some implementations, the communication modules can be identical between the teacher and student models. This means that the teacher encoder portion and the student encoder portion can map their states into the same embedding space: both encoders encode all hidden states (i.e., lower layer and higher layer representations), and decoders decode message to all hidden states. However, in some implementations, a different design can be utilized to further improve student performance during distillation. For example, a message from a student model to a teacher model only encodes lower layer representation. However, in some other implementations, the message from the student model can encode both lower layer and higher layer representations. This can also be accomplished with the message from the teacher to the student.

In some implementations, noise can be added to the input to the models or to an intermediate representation to improve the generalization and robustness of knowledge transfer. Additionally, or alternatively, in some implementations, a noise, such as a small Gaussian noise, can be added to the decoded lower layer hidden state for the teacher model to interpret.

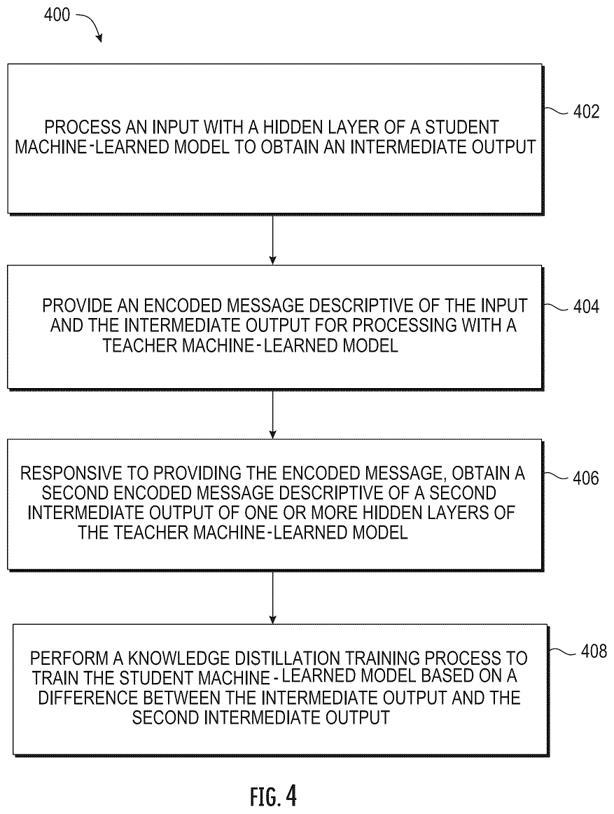

FIG. 4 depicts a flow chart diagram of an example method to perform knowledge distillation training via encoded information exchange according to example embodiments of the present disclosure. Although FIG. 4 depicts steps performed in a particular order for purposes of illustration and discussion, the methods of the present disclosure are not limited to the particularly illustrated order or arrangement. The various steps of the method 400 can be omitted, rearranged, combined, and/or adapted in various ways without deviating from the scope of the present disclosure.

At 402, a computing system can process an input with a hidden layer of a student machine-learned model to obtain an intermediate output.

At 404, the computing system can provide an encoded message descriptive of the input and the intermediate output for processing with a teacher machine-learned model. In some implementations, the encoded message can further include information descriptive of the input. Providing the encoded message can include processing the input and the intermediate output with a machine-learned message encoding model to obtain the encoded message.

At 406, the computing system can, responsive to providing the encoded message, obtain a second encoded message descriptive of a second intermediate output of one or more hidden layers of the teacher machine-learned model. In some implementations, to obtain the second encoded message, the computing system can decode the second encoded message with a machine-learned message decoding model to obtain (a) information descriptive of a second input to the one or more hidden layers of the teacher machine-learned model, and (b) information descriptive of the second intermediate output of the one or more hidden layers of the teacher machine-learned model.

At 408, the computing system can perform a knowledge distillation training process to train the student machine-learned model based on a difference between the intermediate output and the second intermediate output. In some implementations, performing the knowledge distillation training process can include performing a knowledge distillation training process to train the student machine-learned model based on (a) a difference between the intermediate output and the second intermediate output, and (b) a difference between the input and the second input.

In some implementations, the computing system can process the second input with the hidden layer of the student machine-learned model to obtain a third intermediate output. In some implementations, the computing system can provide a third encoded message descriptive of the second input and the third intermediate output for processing with the teacher machine-learned model. In some implementations, responsive to providing the third encoded message, the computing system can obtain a fourth encoded message descriptive of fourth intermediate output of the one or more hidden layers of the teacher machine-learned model. In some implementations, the computing system can perform the knowledge distillation training process to train the student machine-learned model based on a difference between the third intermediate output and the fourth intermediate output. In some implementations, the input can include a low-level hidden state generated based on an initial input to the student machine-learned model, and the intermediate output can include a high-level hidden state.

In some implementations, the machine-learned message decoding model is trained to interpret from a format of low-level intermediate outputs of the teacher machine-learned model to a format of low-level intermediate outputs of the student machine-learned model. In some implementations, the computing system can process the high-level hidden state with one or more layers of the teacher machine-learned model subsequent to the hidden layer to obtain a model output.

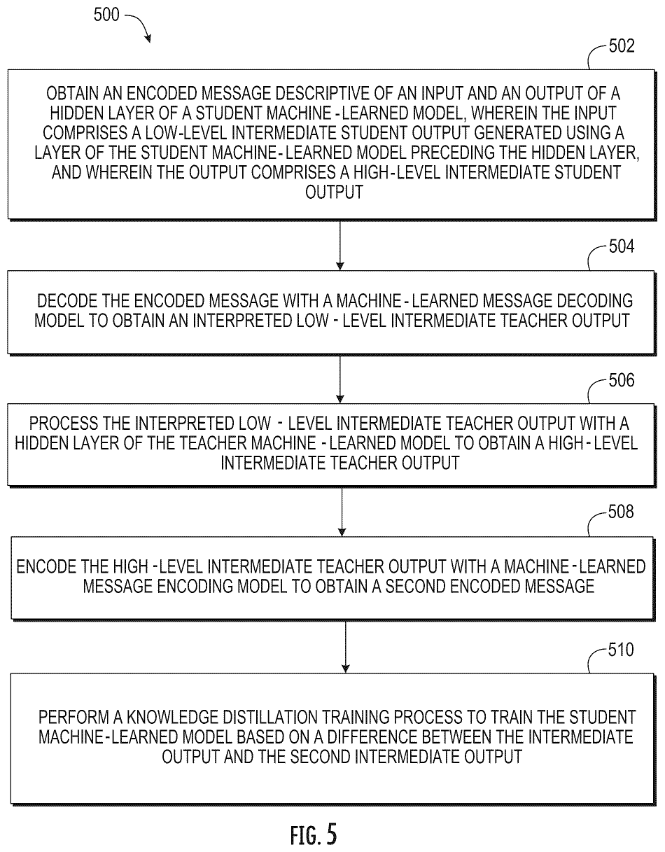

FIG. 5 depicts a flow chart diagram of an example method to perform a knowledge distillation training process with interactive communication according to example embodiments of the present disclosure. Although FIG. 5 depicts steps performed in a particular order for purposes of illustration and discussion, the methods of the present disclosure are not limited to the particularly illustrated order or arrangement. The various steps of the method 500 can be omitted, rearranged, combined, and/or adapted in various ways without deviating from the scope of the present disclosure.

At 502, a computing system can obtain an encoded message descriptive of an input and an output of a hidden layer of a student machine-learned model. The input can include a low-level intermediate student output generated using a layer of the student machine-learned model preceding the hidden layer. The output can include a high-level intermediate student output.

At 504, the computing system can decode the encoded message with a machine-learned message decoding model to obtain an interpreted low-level intermediate teacher output. In some implementations, the machine-learned decoding model is trained to interpret from a format for low-level intermediate student outputs to a format for low-level intermediate teacher outputs.

At 506, the computing system can process the interpreted low-level intermediate teacher output with a hidden layer of a teacher machine-learned model to obtain a high-level intermediate teacher output. In some implementations, the low-level intermediate teacher output can be generated using the layer of the student machine-learned model based on a model input. The computing system can generate a low-level intermediate teacher output using a layer of the teacher machine-learned model that precedes the hidden layer of the teacher machine-learned model.

At 508, the computing system can encode the high-level intermediate teacher output with a machine-learned message encoding model to obtain a second encoded message. In some implementations, encoding the high-level intermediate teacher output can include encoding the high-level intermediate teacher output and the low-level intermediate teacher output with the machine-learned message encoding model to obtain the second encoded message.

At 510, the computing system can provide the second encoded message for performance of a knowledge distillation training process to train the student machine-learned model based on a difference between the high-level intermediate student output and the high-level intermediate teacher output.

In some implementations, the computing system can obtain a third encoded message descriptive of a second input and a second output of the hidden layer of the student machine-learned model. The second input can include an interpreted low-level intermediate student output that is interpreted from the low-level intermediate teacher output of the encoded message. The second output can include a second high-level intermediate student output.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method to generate a second machine learning model based on a first machine learning model, wherein the second machine learning model is structured for more efficient computation, comprising:
processing, by a computing system comprising one or more processor devices, an input with a hidden layer of a student machine-learned model to obtain an intermediate output;
providing, by the computing system, an encoded message descriptive of the input and the intermediate output for processing with a teacher machine-learned model;
responsive to providing the encoded message, obtaining, by the computing system, a second encoded message descriptive of a second intermediate output of one or more hidden layers of the teacher machine-learned model; and
performing, by the computing system, a knowledge distillation training process to train the student machine-learned model based on a difference between the intermediate output and the second intermediate output.

2. The computer-implemented method of claim 1, wherein the encoded message further comprises information descriptive of the input, and wherein providing the encoded message comprises:
processing, by the computing system, the input and the intermediate output with a machine-learned message encoding model to obtain the encoded message.

3. The computer-implemented method of claim 2, wherein the obtaining the second encoded message further comprises:
decoding, by the computing system, the second encoded message with a machine-learned message decoding model to obtain:
(a) information descriptive of a second input to the one or more hidden layers of the teacher machine-learned model; and
(b) information descriptive of the second intermediate output of the one or more hidden layers of the teacher machine-learned model.

4. The computer-implemented method of claim 3, wherein performing the knowledge distillation training process comprises performing, by the computing system, a knowledge distillation training process to train the student machine-learned model based on:
(a) a difference between the intermediate output and the second intermediate output; and
(b) a difference between the input and the second input.

5. The computer-implemented method of claim 4, wherein the method further comprises:
processing, by the computing system, the second input with the hidden layer of the student machine-learned model to obtain a third intermediate output;
providing, by the computing system, a third encoded message descriptive of the second input and the third intermediate output for processing with the teacher machine-learned model;
responsive to providing the third encoded message, obtaining, by the computing system, a fourth encoded message descriptive of fourth intermediate output of the one or more hidden layers of the teacher machine-learned model; and
performing, by the computing system, the knowledge distillation training process to train the student machine-learned model based on a difference between the third intermediate output and the fourth intermediate output.

6. The computer-implemented method of claim 5, wherein the input comprises a low-level hidden state generated based on an initial input to the student machine-learned model, and wherein the intermediate output comprises a high-level hidden state.

7. The computer-implemented method of claim 6, wherein, prior to processing the input comprising the low-level hidden state with the hidden layer of the student machine-learned model, the method comprises:
processing, by the computing system, the initial input with one or more initial layers of the student machine-learned model to obtain the low-level hidden state.

8. The computer-implemented method of claim 7, wherein the machine-learned message decoding model is trained to interpret from a format of low-level intermediate outputs of the teacher machine-learned model to a format of low-level intermediate outputs of the student machine-learned model.

9. The computer-implemented method of claim 7, wherein the method further comprises:
processing, by the computing system, the high-level hidden state with one or more layers of the teacher machine-learned model subsequent to the hidden layer to obtain a model output.

10. A computing system, comprising:
one or more processors;
one or more tangible, non-transitory computer readable media storing computer-readable instructions that when executed by the one or more processors cause the one or more processors to perform operations, the operations comprising:
obtaining an encoded message descriptive of an input and an output of a hidden layer of a student machine-learned model, wherein the input comprises a low-level intermediate student output generated using a layer of the student machine-learned model preceding the hidden layer, and wherein the output comprises a high-level intermediate student output;
decoding the encoded message with a machine-learned message decoding model to obtain an interpreted low-level intermediate teacher output;
processing the interpreted low-level intermediate teacher output with a hidden layer of a teacher machine-learned model to obtain a high-level intermediate teacher output;
encoding the high-level intermediate teacher output with a machine-learned message encoding model to obtain a second encoded message; and
providing the second encoded message for performance of a knowledge distillation training process to train the student machine-learned model based on a difference between the high-level intermediate student output and the high-level intermediate teacher output.

11. The computing system of claim 10, wherein the machine-learned decoding model is trained to interpret from a format for low-level intermediate student outputs to a format for low-level intermediate teacher outputs.

12. The computing system of claim 10, wherein the low-level intermediate teacher output is generated using the layer of the student machine-learned model based on a model input; and
wherein the operations comprise generating a low-level intermediate teacher output using a layer of the teacher machine-learned model that precedes the hidden layer of the teacher machine-learned model.

13. The computing system of claim 12, wherein encoding the high-level intermediate teacher output comprises encoding the high-level intermediate teacher output and the low-level intermediate teacher output with the machine-learned message encoding model to obtain the second encoded message.

14. The computing system of claim 13, wherein the operations further comprise:
obtaining a third encoded message descriptive of a second input and a second output of the hidden layer of the student machine-learned model, wherein the second input comprises an interpreted low-level intermediate student output that is interpreted from the low-level intermediate teacher output of the encoded message, and wherein the second output comprises a second high-level intermediate student output.

15. One or more tangible, non-transitory computer readable media storing computer-readable instructions that when executed by one or more processors cause the one or more processors to perform operations, the operations comprising:
processing a low-level intermediate student output with a hidden layer of a machine-learned student model to obtain a high-level intermediate student output;
generating an interpreted low-level intermediate teacher output based on the low-level intermediate student output;
processing the interpreted low-level intermediate teacher output with a hidden layer of a machine-learned teacher model to obtain a high-level intermediate teacher output; and
performing a knowledge distillation training process to train the student machine-learned model based on a difference between the high-level intermediate student output and the high-level intermediate teacher output.

16. The one or more tangible, non-transitory computer readable media of claim 15, wherein generating the interpreted low-level intermediate teacher output based on the low-level intermediate student output comprises:
encoding the low-level intermediate student output with a machine-learned encoder model to obtain an encoded message; and
decoding the encoded message with a machine-learned decoding model to obtain an interpreted low-level intermediate teacher output.

17. The one or more tangible, non-transitory computer readable media of claim 16, wherein performing the knowledge distillation training process to train the student machine-learned model based on the difference between the high-level intermediate student output and the high-level intermediate teacher output comprises:
encoding the high-level intermediate teacher output with the machine-learned encoder model to obtain a second encoded message;
decoding the encoded message with the machine-learned decoding model to obtain an interpreted high-level intermediate student output; and
performing the knowledge distillation training process to train the student machine-learned model based on the difference between the high-level intermediate student output and the interpreted high-level intermediate student output.

18. The one or more tangible, non-transitory computer readable media of claim 17, wherein the operations further comprise:
training the machine-learned encoding model based on a loss function that evaluates a consistency between the encoded message and the second encoded message.

19. The one or more tangible, non-transitory computer readable media of claim 18, wherein the operations further comprise:
training the machine-learned decoding model based on the loss function that evaluates the consistency between the low-level intermediate student output and the interpreted low-level intermediate student output.

20. A user computing device, comprising:
one or more processors;
one or more tangible, non-transitory computer readable media storing computer-readable instructions that when executed by one or more processors cause the one or more processors to perform operations, the operations comprising:
processing an input with a hidden layer of a student machine-learned model to obtain an intermediate output;
providing an encoded message descriptive of the input and the intermediate output for processing with a teacher machine-learned model;
responsive to providing the encoded message, obtaining a second encoded message descriptive of a second intermediate output of one or more hidden layers of the teacher machine-learned model; and
performing a knowledge distillation training process to train the student machine-learned model based on a difference between the intermediate output and the second intermediate output.
